(19) United States
(12) Patent Application Publication
(10) Pub. No.: US 2013/0201784 A1
(43) Pub. Date: Aug. 8, 2013

(54) BATTER SHAKER

(71) Applicant: Progressive International Corporation, Kent, WA (US)

(72) Inventors: Lawrence M. Hauser, Auburn, WA (US); Joshua Stewart, Seattle, WA (US); Sascha Kaposi, Tacoma, WA (US)

(73) Assignee: Progressive International Corporation, Kent, WA (US)

(21) Appl. No.: 13/623,334

(22) Filed: Sep. 20, 2012

Related U.S. Application Data
(63) Continuation-in-part of application No. 13/547,424, filed on Jul. 12, 2012.
(60) Provisional application No. 61/594,770, filed on Feb. 3, 2012.

(51) Int. Cl. B01F 13/00

(52) U.S. Cl. 366/130

(57) ABSTRACT

A batter shaker includes a container body having a spout. An internal mixing element is carried on an axle or rod for sliding motion up and down the length of the rod, within the container. By shaking or inverting the container, the mixing element travels back and forth along the rod, mixing the batter

### PRIORITY CLAIM

This application is a continuation-in-part of U.S. application Ser. No. 13/547,424 filed Jul. 12, 2012, which claims the benefit of US provisional application Ser. No. 61/594,770 filed Feb. 3, 2012, the contents of which are hereby incorporated by reference.

### FIELD OF THE INVENTION

This invention relates generally to containers for mixing and pouring batters such as pancake batter.

### BACKGROUND OF THE INVENTION

Many salad dressings are composed of a mixture of ingredients such as oil and vinegar which tend to separate from one another when sitting at rest. Consequently, such dressings must be constantly stirred or shaken in order to mix them prior to pouring them onto a salad.

While it is possible to shake a cruet or other such container to mix a dressing, the results are uneven and the shaking or stirring process can create a mess. In addition, if the dressing is poured directly from the bottle without shaking, the result is an application of a dressing that is imbalanced and dominated by the lightest ingredient that has risen to the top. Despite this well-known and long-standing problem, current salad dressing containers remain the same and fail to address the issue.

### SUMMARY OF THE INVENTION

The preferred version of the present invention includes a container having a lid and a main body for holding a volume of dressing. The lid may include a pivoting spout to allow dressing to be poured from the container.

The shaker further includes a mixing element that is moveable along a length of the shaker. Most preferably, the mixing element is carried on a central axis for sliding motion up and down the length of the shaker.

In a version of the invention, the mixing element includes spiraling fins arranged in a complementary fashion to provide greater mixing ability.

### BRIEF DESCRIPTION OF THE DRAWINGS

Preferred and alternative examples of the present invention are described in detail below with reference to the following drawings:

FIG. 1 is a front view of a preferred dressing shaker.

FIG. 2 is a sectional view of a preferred dressing shaker, taken along line A-A in FIG. 1.

FIG. 3 is a perspective view of a preferred lid, axle, and mixing element.

FIG. 4 is a bottom view of the lid, axle, and mixing element as illustrated in FIG. 3.

FIG. 5 is an exploded view of a preferred dressing shaker.

FIG. 6 is a perspective view of an alternate shaker, for use with dressings or batters.

FIG. 7 is an exploded view of the shaker of FIG. 6.

FIG. 8 is a front view of the shaker of FIG. 6, shown with one side of the lid in an open position.

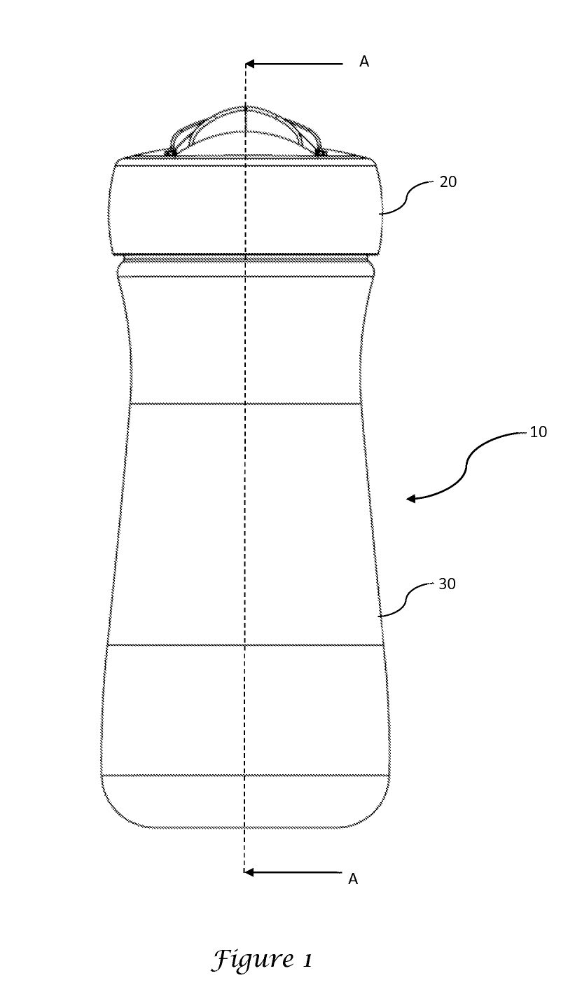

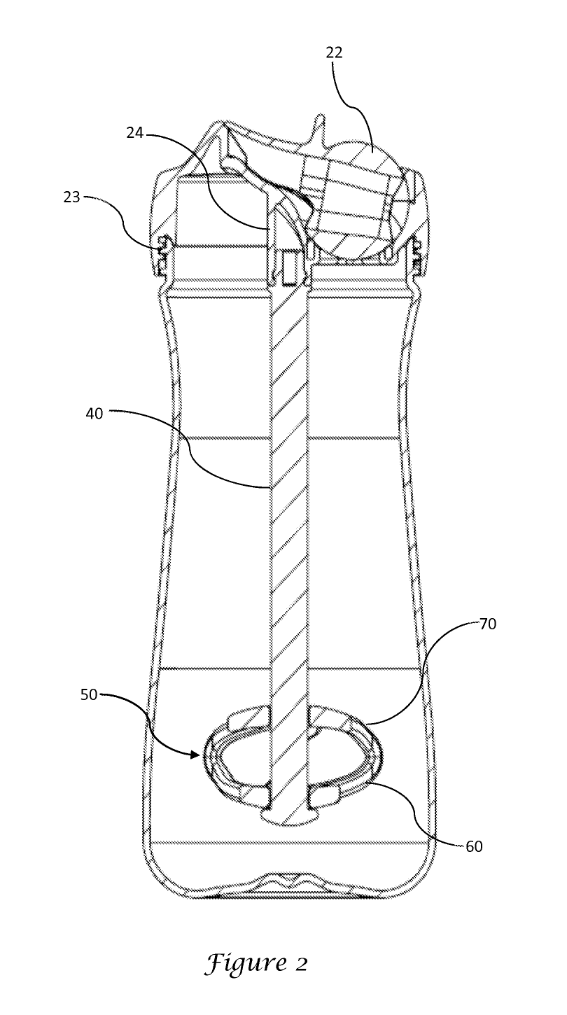

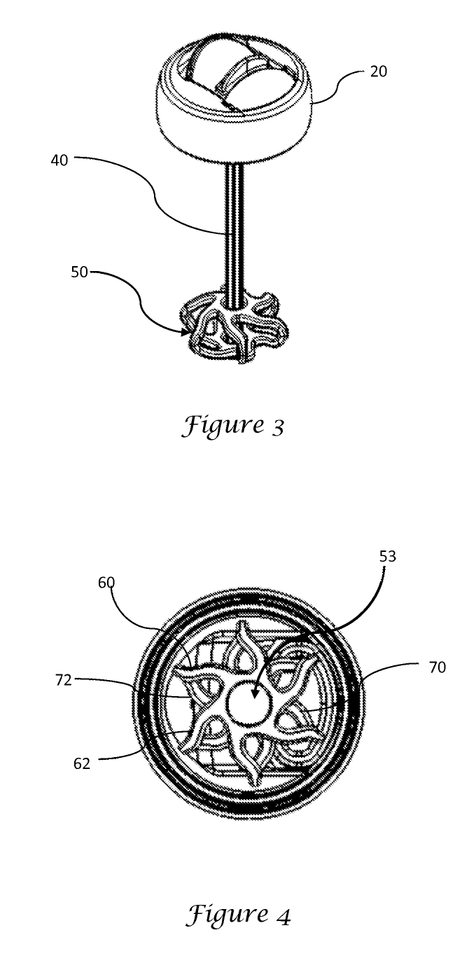

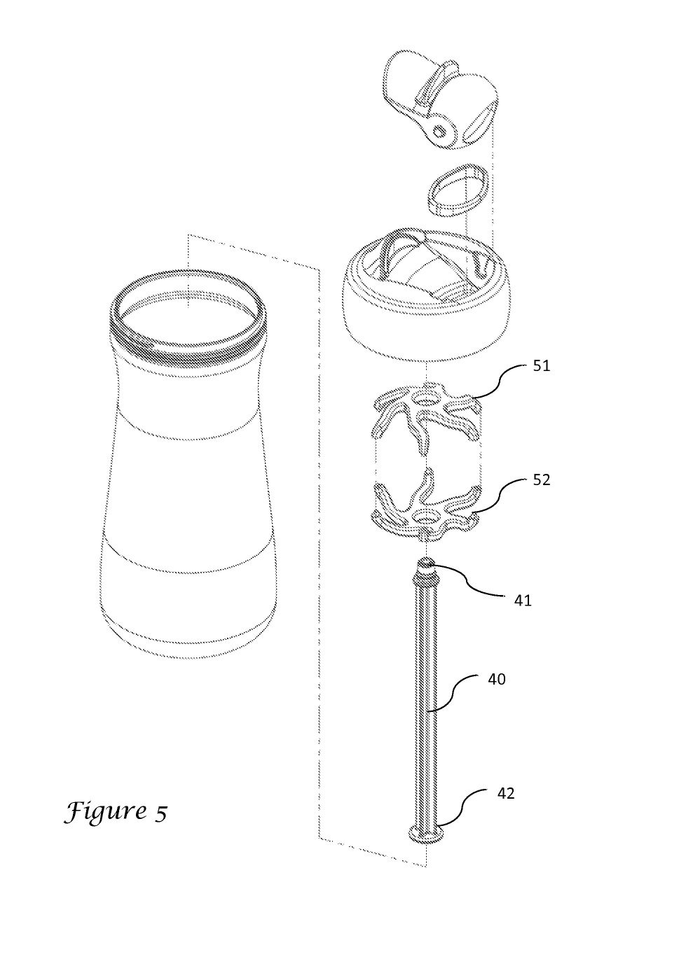

### DETAILED DESCRIPTION OF THE PREFERRED EMBODIMENT

The preferred example of a dressing shaker 10 includes a container 30 and a lid 20. In one version, the container is circular in cross section, forming an upright cylinder with a height greater than the diameter of the circular cross section. In other versions the container may be differently shaped and need not have a height greater than its width.

The lid is removably secured to the container, for example by mating threads 23 provided on the container 30 and lid 20. The lid further includes a spout 22 to enable dressing or other liquids within the container to be poured through the spout. In the illustrated version, the spout 22 is pivotally secured to the lid in a ball and socket arrangement, such that pivoting the spout to a first position creates a continuous passageway through the spout and lid while pivoting the spout to a second stowed position causes a portion of the spout to block the passageway and seal the container.

The lid further includes a centrally positioned socket 24. The socket is sized and configured to receive an upper end 41 of a rod 40. The upper end of the rod may be received within the socket by a press fit, in which the rod is snugly received within the socket for a friction connection. Alternatively, it may include internal ridges, threads, or other surfaces to retain the rod within the socket. In other versions, the orientation may be reversed, such that a stem extends downward from the lid and a socket is formed at the upper end of the rod to receive the stem within it. Yet other configurations are also possible to securely attach the rod to an interior surface on the lid.

While it is preferable to secure the rod to the lid, in other versions of the invention the rod may extend upward toward the lid from a lower portion of the container, rather than extending downward from an internal portion of the lid. A similar attachment configuration may be used in such versions.

The axle or rod serves to guide a mixing element along the length of the container body from an upper end to a lower end of the container. In yet other versions, the guide may be formed along a sidewall of the container, such as in the form of channels or ridges configured in the sidewalls.

A mixing element 50 is carried on the rod 40, with the mixing element being mounted in a manner that allows it to travel along the length of the rod. In the illustrated example, the mixing element includes a central bore 53 that is sized to allow the rod to fit within it. Most preferably, the bore is sized such that it is larger than the widest portion of the rod, making it possible for the mixing element to travel along the length of the rod without contacting the rod. This size relationship allows the mixing element to travel with minimal frictional interference between the mixing element and the rod, and further allows the mixing element to rotate and tumble slightly as it travels along the length of the rod.

At a distal end of the rod, toward the bottom of the container, a flange 42 is formed to provide a stop to limit travel of the mixing element. The flange is sized to have a diameter greater than that of the bore, ensuring that the mixing element cannot fall off the end of the rod. While configured as a flange in the illustrated example, in other versions the rod may be formed with a stop in the shape of a ball, a T, or other shapes that are larger than the bore formed in the mixing element to thereby prevent the mixing element from traveling beyond the end of the rod. In yet other versions there is no stop at the end of the rod, and instead the rod extends to the bottom of the container in a manner such that the bottom of the container will prevent the mixing element from sliding off of the rod.

The mixing element includes a plurality of arms radiating outward from a central hub formed about the bore. In one version, the mixing element includes six arms equally spaced about the hub and extending outward toward the interior surfaces of the sidewalls forming the container. As the mixing element travels back and forth along the length of the rod, the arms pass through the dressing or other liquid with the container, mixing it as it passes through.

In the illustrated version, the mixing element is three dimensional, for example spherical, ellipsoid, ovoid, or otherwise having a dimensional height as well as a width and length. More particularly, the preferred version forms an ellipsoid. As shown, the mixing element is formed from an upper half 51 and a lower half 52, each of the two halves including a plurality of arms radiating outward and curving toward the other half. Thus, the arms of the upper portion arch downward as they extend radially outward, while the arms of the lower portion arch upward as they extend radially outward.

In each of the two portions as illustrated, the upper and lower portions include the same number of arms, which is six as shown. The distal end of each of the arms of the upper portion is secured to a corresponding distal end of an arm of the lower portion to attach the upper portion to the lower portion. The symmetrical shapes of the two halves thereby form the overall ellipsoid shape of the mixing element.

In one example, the upper portion and lower portion are each formed from substantially identical components. Thus, the upper portion 51 is formed as a central hub having a bore and six arms (e.g., 70, 72) radiating outwardly and downwardly. The arms also spiral in a counterclockwise direction, as viewed from the top, rather than radiating straight outward along a radius or diameter passing through the center of the hub. The lower portion is substantially identical to the upper portion, having arms (e.g., 60, 62) in the same configuration, but inverted about the horizontal axis. The tips of the ends of each arm may differ in that one may have a female end and the other a male end in order to connect the two portions, but otherwise the size and shape of the hub and arms is the same.

In use, a mixture such as a salad dressing is placed inside the container. The lid, having the rod and mixing element attached, is placed atop the container and fastened to seal it. By shaking the container in a direction generally along direction defined by the rod, the mixing element will be urged upward and downward along the rod, thereby also passing back and forth through the mixture. The multiple arms and spiral positioning cause the mixture to be mixed thoroughly.

As viewed from the top or the bottom, this inverted arrangement of spiraling arms effectively increases the number of arms that pass through the liquid within the container, providing an improved mixing action as the mixing element extends upward and downward along the length of the rod.

The agitator or mixing element 50 is preferably formed from a material that is sufficiently dense that it will sink in traditional salad dressing mixtures such as oil and vinegar. In some versions the agitator may be formed from plastic materials of sufficient densities, while in other versions it may be formed from metal or ceramic.

The density and configuration of the agitator is such that it will cause mixing of the dressing within the container even without shaking At rest, the agitator sinks to the bottom of the container along with the other components of the mixture that are heaviest. As the container is inverted, the agitator will quickly sink to the bottom (which is the top of the container, with the spout, when inverted). This sinking action quickly draws some of the more dense liquids to the spout, while the arms of the agitator blend the liquids at the same time. While a shaking action is preferred to ensure a more uniform mixture, a single inversion with the agitator as described above will provide a degree of mixing that is superior to a container alone, without an agitator.

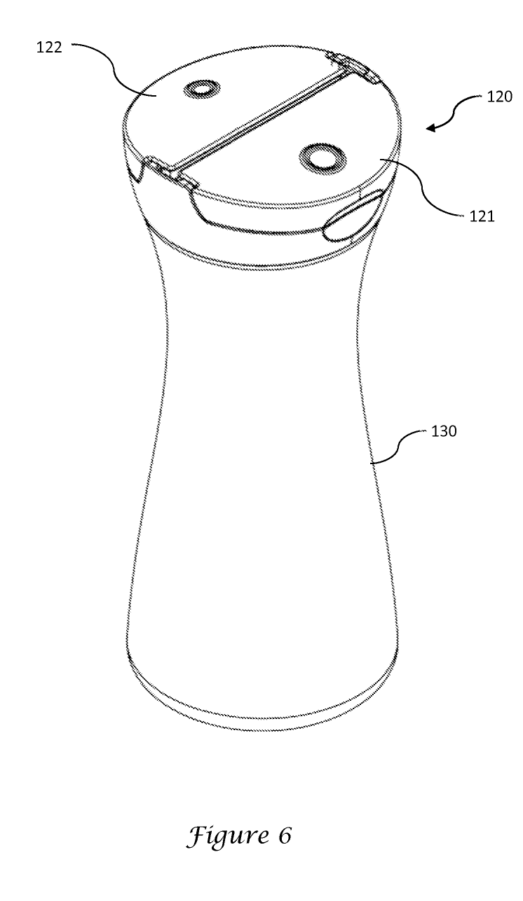

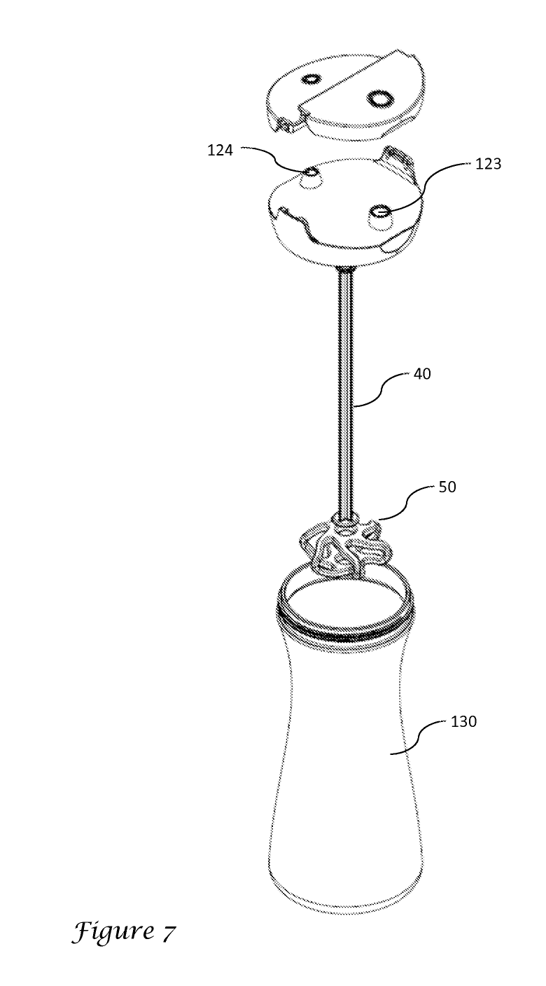

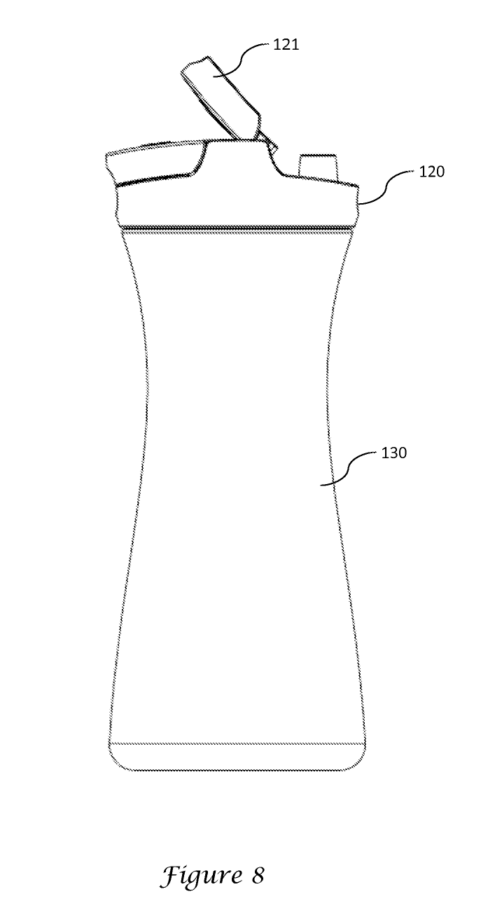

An alternate version of a shaker is shown in FIGS. 6-8. This alternate version is well-suited for shaking and pouring dressings, and may alternatively be used for mixing and pouring other contents, such as batter for pancakes or other food items.

As shown, the shaker includes a container body 130 having a lid 120 carried on a neck at the upper end of the container body. In this case, as explained further below, the container 130 is preferably formed from a semi-rigid or flexible material allowing the container to be squeezed to help to pour thicker contents such as pancake batter from the container.

The shaker further includes a rod 40 carrying a mixing element 50, as described above. Likewise, the rod may be attached to the lid, or may alternatively be attached to the container. Most preferably, however, the rod is mounted and frictionally held within a cavity formed in an interior side of the lid.

In a preferred version, the lid 120 includes at least one spout, and more preferably it is formed with two spouts 123, 124. As illustrated, each of the spouts is formed as a rounded or cylindrical neck extending upward from one side of the lid and terminating in a circular rim. In each case, the spout forms a passageway from the interior of the container to the outside of the container, thereby allowing batter within the container to flow through the spout and out of the container.

When two spouts are provided, it is preferable that one spout is larger than the other. As illustrated, the first spout 123 is larger than the second spout 124. This difference in the spout sizes allows for a finer control of the batter, if desired, to allow batter to be poured into smaller spaces and in a more controlled flow. Alternatively, the larger spout allows batter to be poured faster.

In one example, the lid 120 includes a pair of pivotal caps 121, 122 to seal each of the spouts. The pivotal caps may be secured to a pair of posts formed on the lid diametrically opposite one another, thereby allowing a semi-circular shaped cap to be flipped upward from a perimeter on the lid to a vertical position to open the spout. The lid preferably includes a snap-fit feature to retain the cap in a closed position.

In a preferred example, the container body includes external volumetric markings to facilitate the ability to pour the ingredients directly into container body and measure them within the container body, rather than using separate measuring cups.

In use, batter is placed in the container, either in a mixed or unmixed form. If unmixed, the dry components (such as a mix containing flour, sugar, baking soda, and other such ingredients) are added to the container with wet ingredients (such as water). When the wet and dry ingredients are within the container, the lid and caps are closed and the shaker is shaken to mix the ingredients. The shaking action causes the mixing element 50 to slide back and forth along the rod 40, thereby passing through the ingredients and mixing them.

After the batter is mixed, a cap may be opened to allow batter to be poured from the shaker. As batter is typically somewhat thick and may not actually pour readily, the pouring ability is improved by the use of a somewhat flexible container body, allowing the container to be squeezed to urge the batter from the container.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A batter shaker, comprising:
a container body having sidewalls defining an interior space, the container further having a base at a lower end of the container body and a neck at an upper end of the container body, the container body being formed from a flexible or semi-rigid material whereby the sidewalls are compressible toward the interior space under influence of an outer force exerted on the sidewalls;
a lid attached to the neck of the container body and having at least one spout;
a guide supported within the container body between the upper end and the lower end; and
a mixing element slideably moveable along the guide;
whereby shaking the container body causes the mixing element to move along a path defined by the guide and to mix the batter within the container body.

2. The batter shaker of claim 1, wherein the guide further comprises a rod positioned centrally within the container body.

3. The batter shaker of claim 2, wherein the guide is attached to the lid and extends downward toward the lower end of the container.

4. The batter shaker of claim 3, wherein the mixing element comprises a central bore and the guide is received within the central bore.

5. The batter shaker of claim 4, wherein the mixing element comprises a hub surrounding the central bore and a plurality of arms radiating outward from the hub.

6. The batter shaker of clam 5, wherein the mixing element comprises an upper portion and a lower portion joined together, each of the upper portion and the lower portion having a hub surrounding the central bore and a plurality of arms radiating outward from the hub.

7. The batter shaker of claim 6, wherein the mixing element forms an ellipsoid, and further wherein at least some of the plurality of arms are formed in a spiral configuration.

8. The batter shaker of claim 6, wherein the arms of the upper portion of the guide are configured to spiral in a first direction and the arms of the lower portion of the guide are configured to spiral in a second direction, the second direction being opposite the first direction.

9. The batter shaker of claim 4, wherein the guide further comprises a stop formed on the guide, the stop being configured to retain the mixing element on the guide when the mixing element is adjacent the lower end of the container.

10. The batter shaker of claim 4, wherein the at least one spout comprises a first spout and a second spout, the second spout being larger than the first spout.

11. The batter shaker of claim 10, wherein the lid further comprises a first cap for selectively sealing the first spout and a second cap for selectively sealing the second spout.

12. A method for mixing batter, comprising,
providing a batter shaker in accordance with claim 1;
placing ingredients for forming batter within the batter shaker;
shaking the batter shaker to cause the mixing element to travel along the guide and mix the batter; and
pouring the batter from the batter shaker.

13. The method of claim 12, wherein the guide further comprises a rod positioned centrally within the container body.

14. The method of claim 13, wherein the mixing element comprises a central bore and the guide is received within the central bore.

15. The method of clam 13, wherein the mixing element comprises an upper portion and a lower portion joined to form an ellipsoid, each of the upper portion and the lower portion having a hub surrounding the central bore and a plurality of arms radiating outward from the hub.

16. The method of claim 14, wherein the at least one spout comprises a first spout and a second spout, the second spout being larger than the first spout, the method further comprising selecting one of the first spout or the second spout, such that the step of pouring the batter further comprises pouring the batter from the selected first spout or second spout.

17. The method of claim 16, wherein the step of pouring the batter further comprises squeezing the container body to urge the batter from the batter shaker.
